(19) United States
(12) Patent Application Publication
(10) Pub. No.: US 2015/0350153 A1
(43) Pub. Date: Dec. 3, 2015

(54) SYSTEM AND METHOD FOR ACCOUNT-BASED DNS ROUTING

(71) Applicant: Vonage Business Solutions, Inc., Atlanta, GA (US)

(72) Inventors: Randy Layman, Marietta, GA (US); Robert Michael Smith, Atlanta, GA (US); Jonathan Alexander, Roswell, GA (US)

(73) Assignee: Vonage Business Solutions, Inc., Atlanta, GA (US)

(21) Appl. No.: 14/291,602

(22) Filed: May 30, 2014

(51) Int. Cl. H04L 29/12; H04M 7/00; H04L 29/08

(52) U.S. Cl. CPC H04L 61/1511; H04L 67/2814; H04M 7/0075; H04M 7/009

(57) ABSTRACT

A system and method are disclosed herein for account-based domain name system (Account-Based DNS) routing in an Internet Protocol (IP) service network. An IP device is provided for generating SIP or IP service requests. A configuration database that contains an association between a customer account identifier and an account-based DNS address is used by a provisioning service for assigning an account-based DNS address to the IP service request. A proxy server is configured to receive the IP service request. The proxy server is in communication with a server database comprising an association between the customer account identifier, the type of SIP service request and a plurality of feature servers, wherein the proxy server dynamically assigns a forwarding account-based DNS address to the SIP service requests based on the association in the server database so that the SIP service request is forwarded to the assigned feature server.

### FIELD OF THE INVENTION

The present invention relates generally to a system and method for Internet protocol (IP) routing and, more particularly, to an account-based domain name system (Account-Based DNS) and method for routing IP and session initiation protocol service requests.

### BACKGROUND OF THE INVENTION

A Private Branch Exchange (PBX) is a telephone exchange system that facilitates connections among the internal telephones of an organization, such as a corporation, business, or other private telephone network. The PBX allows these internal telephones to connect to the public switched telephone network (PSTN) via trunk lines and/or via the Internet.

A hosted PBX system delivers PBX functionality as a service, available over the PSTN and/or the Internet. A telephone company typically provides hosted PBXs using equipment located on the premises of the telephone company's exchange. In a hosted PBX system, the customer organization does not need to buy or install PBX equipment and the telephone company can use the same switching equipment to service multiple PBX hosting accounts in multiple locations. Furthermore, Voice-over-Internet-Protocol (VoIP) gateways can be combined with traditional PBX functionality enabling businesses and organizations to use their managed Internet/Intranet to help reduce long distance expenses and to enjoy the benefits of a single network for voice and data, which gives greater cost savings, mobility and increased redundancy.

A hosted VoIP PBX system allows its users to place calls from, for example, IP telephony devices over the Internet. An IP telephony device may include any type of device which is capable of interacting with an IP telephony system, which may comprise a hosted VoIP system, to conduct a communication. An IP telephony device could be an IP telephone, a computer running IP telephony software (sometimes referred to as a “softphone”), a telephone adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Session Initiation Protocol (SIP) may be used by an IP telephony device to communicate with an IP telephony system, which may comprise a hosted virtual PBX, for example, for the purpose setting up and tearing down VoIP communications. For example, a SIP INVITE message may be transmitted by an IP telephony device to the IP telephony system to signal a request to initiate a VoIP communication. The details and functionality of SIP can be found in the Internet Engineering Task Force (IETF) Request for Comments (RFC) Paper No. 3261 entitled, “SIP: Session Initiation Protocol,” herein incorporated in its entirety by reference.

The virtual PBX has the ability to route calls and other communications out to traditional communications networks such as PSTN systems. In a common configuration, an IP telephony device may have a static Internet protocol (IP) address in its configuration settings that is used for addressing IP packets transmitted from the IP telephony device. These IP packets may, for example, comprise service requests, such as a request to initiate, transfer, or terminate a call, or to be forwarded to a fixed set of servers or load-balancers.

IP addresses are typically a set of numbers that identify the location of a port in an Internet protocol network. These addresses may be difficult to remember. Therefore, Internet architecture includes natural language addressing mechanisms in the form of Universal Resource Locator (URL) addresses. These URL addresses include typical web addresses such as “www.google.com.” A URL address allows an administrator or system to assign a natural language address to an IP device or service. This natural language address can be resolved back to an IP address using a Domain Name System (DNS) server.

The DNS, which resides on a hierarchy of special database servers, implements a distributed database to store URL and IP address information for public hosts on the Internet. When client IP telephony devices issue requests involving Internet host names, a software tool called the DNS resolver (usually built into the network operating system) first contacts a DNS server on the lowest level of hierarchy to determine the destination server's IP address. If the DNS server does not contain the needed mapping address, it will in turn forward the request to a different DNS server at the next higher level in the hierarchy. After potentially several forwarding and delegation messages are sent within the DNS hierarchy, the IP address for the given Internet host name eventually arrives at the DNS resolver. The DNS resolver is then able to direct the IP telephony device to the destination server IP address as resolved by DNS.

A hosted VoIP PBX environment needs to provide a way to scale capacity as the number of IP telephony devices and the associated frequency of SIP service requests increases. It is also desirable to minimize the complexity and time required to add capacity, redirect IP telephony devices and system load, or to provide multiple tiers of capacity so, for example, SIP service requests from some IP telephony devices associated with specific users might always be routed to servers carrying a lighter load to help ensure a more dedicated level of service for the specific users. A further need exists to provide an easy way to redirect a subset of IP telephony devices to different server resources without changing the server routing information in the IP telephony devices' configuration settings.

The present invention meets one or more of the above-referenced needs as described herein in greater detail.

### SUMMARY OF THE INVENTION

The present invention relates generally to a system and method for Internet protocol (IP) routing and, more particularly, to an account-based domain name system (Account-Based DNS) and method for routing IP and session initiation protocol service requests. Briefly described, aspects of the present embodiments include the following.

A system is disclosed herein for routing Internet protocol service requests. The system comprises a proxy that is configured to receive a service request from an Internet protocol (IP) device. The proxy receives the service request and in response, it generates a universal resource locater (URL) based on at least one parameter contained in the service request. A domain name system (DNS) is configured to receive the URL, resolve the URL into an address, and transmit the address to the proxy. A feature server associated with the address is configured to receive the service request from the proxy and to transmit a message responsive to the service request.

In an alternative embodiment, a method is disclosed herein for routing service requests. In the method, a service request received from an Internet protocol (IP) device. A universal resource locater (URL) address is generated based on at least one parameter contained in the service request. A domain name system (DNS) is configured to receive the URL and resolve the URL into an address. The service request can then be transmitted to the resolved address.

The above features as well as additional features and aspects of the present invention are disclosed herein and will become apparent from the following description of preferred embodiments of the present invention.

### BRIEF DESCRIPTION OF THE DRAWINGS

The foregoing summary, as well as the following detailed description of illustrative embodiments, may be understood in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of an exemplary embodiment of a system for Account-Based DNS routing in a hosted VoIP environment;

FIG. 2 is a flowchart diagram of an exemplary embodiment of a method for Account-Based DNS routing in a hosted VoIP environment;

FIG. 3 is a block diagram of an exemplary computing environment that may be used in conjunction with example embodiments and aspects.

### DETAILED DESCRIPTION

Before the present methods and systems are disclosed and described in greater detail hereinafter, it is to be understood that the methods and systems are not limited to the disclosed methods, components, or implementations. It is also to be understood that the terminology used herein is for the purpose of describing particular aspects and embodiments only and is not intended to be limiting.

As used in the specification and the appended claims, the singular forms “a,” “an,” and “the” include plural referents unless the context clearly dictates otherwise. “Optional” or “optionally” means that the subsequently described event or circumstance may or may not occur, and the description includes instances where the event or circumstance occurs and instances where it does not.

Throughout the description and claims of this specification, the word “comprise” and variations of the word, such as “comprising” and “comprises,” mean “including but not limited to,” and are not intended to exclude, for example, other components, integers or steps. “Exemplary” means “an example of” and is not intended to convey an indication of preferred or ideal embodiment. “Such as” is not used in a restrictive sense, but for explanatory purposes.

Disclosed herein are components that can be used to perform the disclosed methods and systems. It is understood that when combinations, subsets, interactions, groups, etc. of these components are disclosed that although specific reference to each various individual and collective combinations and permutations cannot be explicitly disclosed, each is specifically contemplated and incorporated herein, for all methods and systems. This applies to all aspects of this specification including, but not limited to, steps in disclosed methods. Thus, if there are a variety of additional steps that can be performed it is understood that each of the additional steps can be performed with any specific embodiment or combination of embodiments of the disclosed methods.

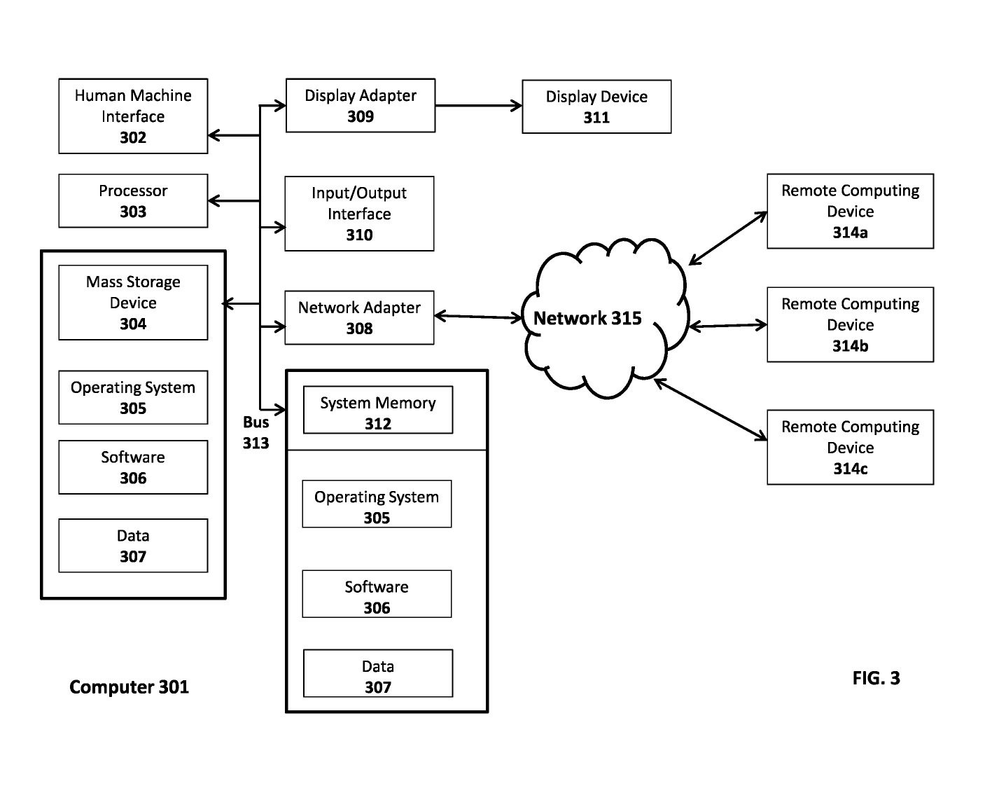

As will be appreciated by one skilled in the art, the methods and systems may take the form of an entirely new hardware embodiment, an entirely new software embodiment, or an embodiment combining new software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, non-volatile flash memory, CD-ROMs, optical storage devices, and/or magnetic storage devices. An exemplary computer system is detailed in the discussion of FIG. 3 below.

Embodiments of the methods and systems are described below with reference to block and flowchart diagrams of methods, systems, apparatuses and computer program products. It will be understood that each block of the block diagrams and flowchart diagrams, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks contained in the block diagram and flowchart diagrams support combinations of means for performing the specified functions, combinations of steps for performing the specified functions and program instruction means for performing the specified functions. It will also be understood that each block of the block diagram and flowchart diagrams, and combinations of blocks in the block diagram and flowchart diagrams, can be implemented by special purpose hardware-based computer systems that perform the specified functions or steps, or combinations of special purpose hardware and computer instructions.

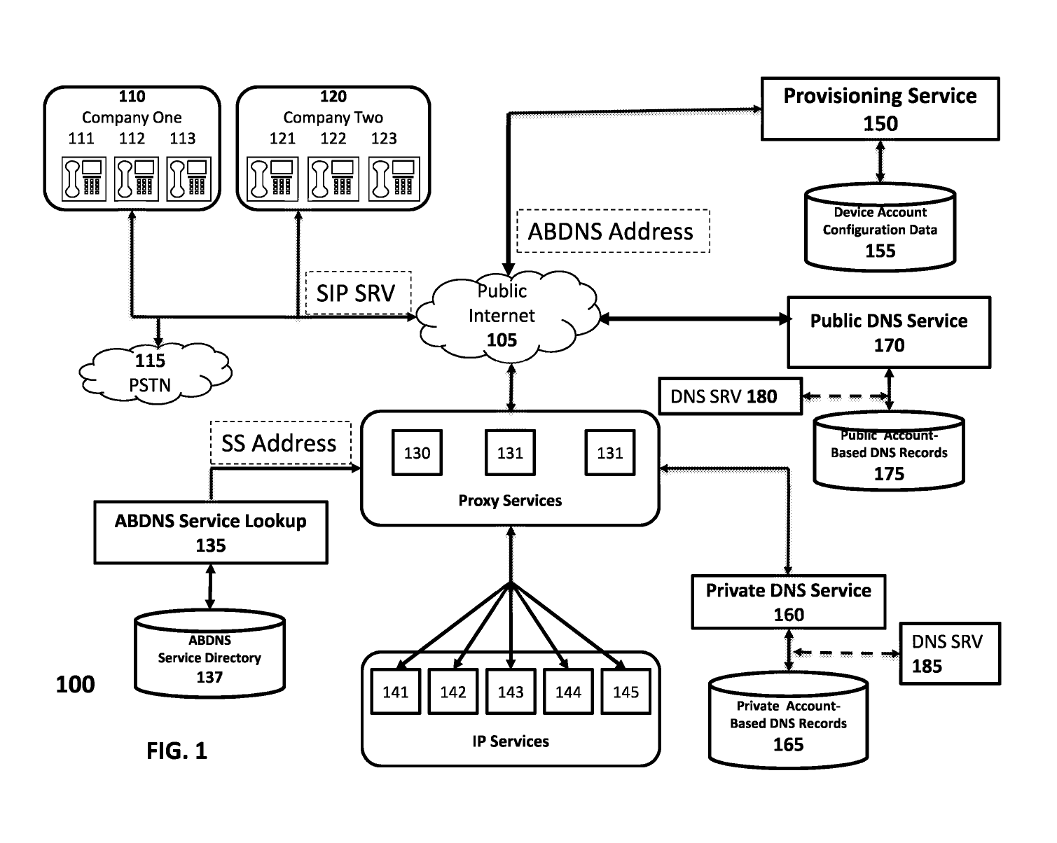

FIG. 1 is a block diagram that details the various aspects of an exemplary embodiment in which the present methods and systems can operate. More specifically, FIG. 1 illustrates a block diagram for an exemplary embodiment of a VoIP Telephony System 100 for providing an Account-Based DNS (ABDNS) routing system and method. The ABDNS routing system and method can be used for routing service requests, for example, a Session Initiation Protocol (SIP) or an Internet Protocol (IP) device service request.

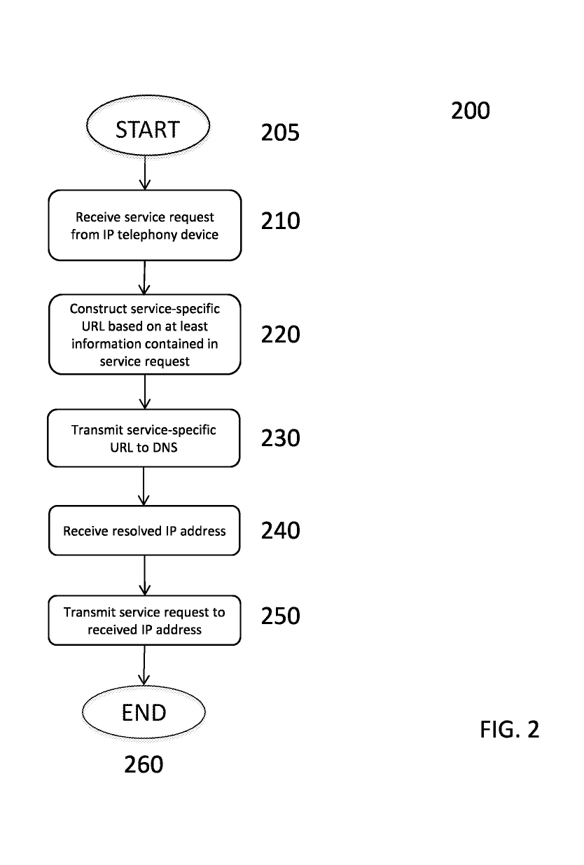

The discussion of FIGS. 1-2 includes examples related to IP telephony devices in the VoIP Telephony System 100. However, those skilled in the art will appreciate that the present system and methods can operate in any IP network environment and are not limited to telephony systems. In fact, the systems and methods disclosed herein are also applicable to systems related to IP devices (as opposed to only IP telephony devices) and other computer networking system components that employ both digital and analog equipment. One skilled in the art will also appreciate the fact that the respective functions described herein can be performed by software, hardware, or a combination of software and hardware.

In an embodiment, a VoIP Telephony System 100 is used by one or more companies 110, 120 for intra-company telecommunications and for telecommunications to and from outside parties via the Internet 105 or a publicly switched telephone network (PSTN) 115. The one or more companies (subscriber or customer) 110, 120 each represent at least one account. The companies 110, 120 each have one or more IP telephony devices 111-113, 121-123 that have been assigned an IP address and/or a media access control address (MAC address). Having been provided an IP or MAC address, the IP telephony devices 111-113, 121-123 can communicate over the Public Internet (hereinafter, the Internet) 105 or over another Internet protocol (IP) network. Each company 110, 120 is provided with a customer account from a VoIP or communications services provider or other source. Each IP telephony device 111-113, 121-123 that is associated with a particular company 110, 120 is assigned a DNS address for routing SIP or IP service requests. For example, SIP requests include SIP INVITE, SIP ACK or SIP BYE to initiate, acknowledge or terminate calls respectively. IP service requests can include Hypertext Transfer Protocols (HTTP), for example, HTTP GET or HTTP POST, which requests data from a specified resource or submits data to be processed by a specified resource, respectively.

In FIG. 1, a Provisioning Service 150 is used to configure each IP telephony device 111-113, 121-123 associated with a particular company 110, 120 with an Account-Based DNS (ABDNS) address. Therefore, each IP telephony device 111-113, 121-123 has assigned to it a device-specific ABDNS address (“DS address”) that it can use to route service requests to the VoIP Telephony System 100. In some embodiments, an operator can manually assign these DS addresses to the IP telephony devices 111-113, 121-123. In alternative embodiments, the Provisioning Service 150 assigns the DS addresses to the IP telephony devices 111-113, 121-123 automatically.

Provisioning refers to the network-wide configuration, deployment and management of multiple types of information technology (IT) system resources. Provisioning can involve the setup of equipment; assignment of DS addresses; and configuration of IP telephony devices to ensure device, network, equipment, and option compatibility. The provisioning process is applied to IP telephony devices 111-113, 121-123 to ensure enterprise resource compatibility and security. The Provisioning Service 150 may further keep track of which IP telephony devices 111-113, 121-123 are associated with which companies 110, 120 and subsequently, which customer account. This information can be stored in a Device Account Configuration Database 155. In addition, the Provisioning Service 150 tracks and monitors customer account access information to allow customers, and thereby an associated IP telephony device 111-113, 121-123, access to the communications of VoIP Telephony System 100. Typically, a communications service provider oversees the provisioning process.

In an embodiment, each IP telephony device 111-113, 121-123 is assigned a unique account identifier. In the exemplary embodiment, each IP telephony device has an IP or MAC address. The Provisioning Service 150 associates the IP or MAC address of each IP telephony device 111-113, 121-123 with an assigned DS address in its Device Account Configuration Database 155. The IP telephony devices 111-113, 121-123 may also store these assigned DS addresses in a cache within the devices 111-113, 121-123. Therefore, when the IP telephony device initiates a SIP (or IP) service request, the service request is routed over the Internet 105 using the DS address.

Examples of DS addresses include URL addresses such as

“http://www.vonage.SIPaccount1.com” or “http://www.vocalocity.SIPaccount5.com.” In these examples, the service provider's name is listed first, “Vonage” or “Vocalocity,” followed by the unique account identifier, “SIPaccount1” or “SIPaccount5,” respectively.

The DS addresses assigned to the IP telephony devices 111-113 and 121-123 are used to route SIP service requests generated by the IP telephony devices 111-113 and 121-123 within the VoIP telephony system 100. The ABDNS addresses assigned to these SIP service requests are resolved into IP addresses by the Public Domain Name System (PDNS) 170. In an exemplary embodiment, the PDNS 170 resolves the DS address assigned to the SIP service request to the IP address of a particular Proxy Service 130-132. Once the IP address of the particular Proxy Service 130-132 is known, the SIP service request can be routed to that particular proxy.

The DS addresses assigned to the IP telephony devices 111-113, 121-123, and thereby the SIP service requests they generate, can be resolved to an IP address of a particular Proxy Service 130-132 that is designated to process the SIP service requests from a particular company's 110, 120 account. For example if IP telephony device 112 is assigned the DS address “http://www.vonage.SIPaccount1.com,” requests from this IP telephony device 112 may be routed to Proxy Service 130, which has been associated with account 1. Similarly, if IP telephony device 122 is assigned the DS address “http://www.vonage.SIPaccount2.com,” requests from this IP telephony device 112 would be routed to a Proxy Service 132 associated with account 2.

IP telephony devices 111-113, 121-123 within the same company (or associated with the same subscriber) can also have different accounts and corresponding, alternate routing. For example, IP telephony device 113 may also be associated with Company One 110, along with IP telephony device 112 (which has been assigned to account 1). However, if IP telephony device 113 is assigned the DS address “http://www.vonage.SIPaccount3.com,” requests from this IP telephony device 113 may be routed to Proxy Service 131, associated with account 3. This makes it possible for each IP telephony device 111-113 and 121-123 to communicate with the particular Proxy Service 130-132 associated with the communication service provider's domain. Furthermore, the Proxy Service 130-132 may thereby be associated with the account assigned to the particular IP telephony device 111-113, 121-123.

The PDNS 170 can record or cache these DS address records in a Public Account-Based DNS Records 175 database. Via this mechanism, it is possible for the PDNS 170 to resolve different DS addresses to a plurality of separate Proxy Services 130-132. Using the example above, the PDNS 170 can also migrate or distribute the different DS addresses among multiple Proxy Services 130-132 by updating or changing the account-based DNS records in the Public Account-Based DNS Records database 175. The PDNS 170 may also employ similar features and functionality using the DNS SRV (server) 180 protocol described below.

The PDNS 170 is used to resolve the DS addresses assigned to the IP telephony devices 111-113, 121-123 to IP addresses that can be used to route service requests from the IP telephony devices 111-113, 121-123 to any number of servers or Proxy Services 130-132 within the VoIP telephony system 100. As described above, the Provisioning Service 150 may assign DS addresses to the IP telephony devices 111-113, 121-123 for routing to a specific Proxy Service 130 based on characteristics or attributes of the IP telephony devices' 111-113, 121-123 accounts. Assignments may be based on, for example, geographic proximity.

For example, if IP telephony device 111 is located in the state of Vermont, the Provisioning Service 150 may assign to it a DS address,

“http://www.vonageNE.SIPaccoun1.com,” that routes it to a Proxy Service 130 on the East Coast. Similarly, if IP telephony device 121 is located in the state of Ohio, the Provisioning Service 150 may assign to it a DS address, “http://www.vonageMW.SIPaccount2.com,” that routes it to a Proxy Service 132 in the Midwest. Although DS addresses related to geo-location are used in the previous examples, any number of account-distinguishing attributes could be used for routing service requests to a Proxy Service 130-132 associated with an attribute of the account associated with a particular IP telephony device 111-113, 121-123.

In an alternative embodiment, the Provisioning Service 150 may assign a DS address to each IP telephony device 111-113, 121-123. When an IP telephony device 111-113, 121-123 transmits a service request containing its DS address, the PDNS 170 may optionally use the DNS SRV 180 protocol to resolve the assigned DS address. The DNS SRV 180 protocol comprises a service record that is a specification of data in the DNS for defining the location (i.e. the hostname and port number) of servers for specified services. In an embodiment, the DNS SRV allows administrators to use several servers for a single domain, to move services from host to host easily, to allow for proportional distribution among servers, and to designate some hosts as primary servers for a service and others as backups. The list of addresses for a server and the corresponding server attributes can be stored in a server address directory in the Public Account Based DNS Records 175 database.

In an exemplary embodiment, instead of the DNS SRV 180 having just one hostname or port number in the server address directory in the Public Account Based DNS Records 175 database associated with a given DNS address, it may instead have a list of hostnames and port numbers for each DNS Address. Each hostname or port number listed for a given DNS address may be different to allow for different types of services or protocols (such as one for SIP, one for HTTP, one for FTP, etc.). For example, for a given account, the DNS SRV 180 may provide a hostname, port number or IP address to the PDNS 170 for routing SIP service requests from IP telephony device 111 to a Proxy Service 130 on East Coast of the United States as described in the example above. Meanwhile, SIP service requests from IP telephony device 121 may be provided a hostname, port number or IP address that routes that service request to a Proxy Service 132 in the Midwestern United States as also described in the example above. Therefore, each SIP service request from the same account can routed to a particular Proxy Service 130-132 based on attributes of the individual IP telephony device 111-113, 121-123 or the account for the company 110, 120.

Each Proxy Service 130-132 is a server (a computer system or an application) that acts as an intermediary for requests from clients (e. g. SIP, IP or Network devices) seeking resources from other servers. A client connects to the Proxy Services 130-132, requesting some service, such as a file, connection, web page, or other resource available from a different server and the Proxy Services 130-132 evaluate the request as a way to simplify and control its complexity.

The Proxy Services 130-132 may forward service requests received from the IP telephony devices 111-113, 121-123 to one or more IP Services 141-145. In one embodiment, the Proxy Services 130-132 analyze incoming service requests to determine the type of the service request and account information associated with the service request; other sources, such as an account information database, may also be queried. Once the Proxy Services 130-132 determine there is a need to call on a service or server 141-145 to satisfy the service request, they may invoke the ABDNS Service Lookup 135 for further processing as described in further detail below. In some embodiments, as depicted in FIG. 1, the ABDNS Service Lookup 135 system may be a separate server from the Proxy Services 130-132. In other embodiments, the ABDNS Service Lookup 135 may be co-located with the Proxy Services 130-132.

The ABDNS Service Lookup 135 system is configured to parse a service request and to dynamically create a service-specific ABDNS address (“SS address”) for further routing of the service request. The SS address may be constructed in a way to transparently indicate by the URL itself various information associated with the service request, including but not limited to an account ID, service type, or service level. As explained, by constructing the SS address, such information may be passed to a DNS service that is pre-provisioned to resolve the received SS address into an IP (or other network protocol) address.

The ABDNS Service Lookup 135 may determine an account ID associated with the service request by parsing the service request itself, for example, in the message header. In some embodiments, the service request message header will contain an indication of the account ID, possibly in the form of the original DS address.

The ABDNS Service Lookup 135 may also determine a service type that is required to satisfy the service request (e.g. “Database,” “Call handler,” or “Cache”). This determination may be based on various predetermined rules, taking into account, by way of non-limiting example, (i) the content of the service request itself (for example, in a message header); (ii) the protocol of the message (for example SIP, LDAP, XMPP or TCP), (iii) the port on which the incoming service request was received, or (iv) information found in the message body of the service request (for example, an account ID or user ID), which may also be used to further look up information from another source (such as an account or user information database); (v) the IP address or other identifying information from the device or client that sent the service request, which might be contained in the message header or message body, which may also be used to further look up information such as a geographic code or recent service quality results from another source. Types of services may include SIP-related call processing, database services, messaging services, cache services, HTTP requests, and the like.

Similarly, the ABDNS Service Lookup 135 system may determine a service level associated with the request. Again, this information may be derived based on various predetermined rules, such as the content of the service request or stored account information. A determined service level may indicate whether the service request should be given priority treatment, which may result in the request being forwarded to specific resources configured to provide superior quality of service, for example.

Based on information associated with the service request, for example, the account ID, service type, or service level, the ABDNS Service Lookup 135 may construct an SS address. A variety of means could be used to achieve this determination.

In some embodiments, an ABDNS Service Directory 137 communicatively coupled to the ABDNS Service Lookup 135 can include a full mapping of every DS address used for the Proxy Service 130-132 and service combination to a specific SS address. For example “www.vonage.SIPaccount1.com” could be mapped for purposes of providing “Database” services to “www.vonage.DBaccount1.com.” This universal resource locator (URL) address may ultimately be mapped to one of IP Services 141-145 by the Private DNS Service 160 as explained below. Similarly “www.vonage.SIPaccount2.com” could be mapped for purposes of providing “Database” services to “www.vonage.DBaccount2.com,” and so on. Service requests from different accounts could, of course, be ultimately mapped to the same internal IP Service 141-145.

In other embodiments, the ABDNS Service Lookup 135 may be configured to programmatically construct an SS address based on the information associated with the service request

For example, the ABDNS Service Directory 135 might determine an account ID “account 1” and service type “Database” associated with the incoming service request. It may further be configured to construct an SS address based on the pattern

“http://www.vonage.[service_type].[account_id].com/.” Therefore, the Service Lookup 135 creates the SS address “www.vonage.DB.account1.com”.

In an embodiment, once the SS address has been assigned to the service request, the Proxy Service 130-132 forwards the service request to the Private DNS Service 160, which resolves the SS address to an IP address of one of several IP Services 141-145 servers. The Private DNS Service 160 uses the SS address of the service request to match the Service request to the IP address of an IP Services 141-145 in its directory.

In a further embodiment, DNS SRV 185 can assign attributes to the SS address that, in turn, provide the Private DNS Service 160 with a list of hostnames, port numbers or IP addresses for the associated servers in IP Services 140. This list of hostnames, port numbers or IP addresses can be used to determine the distribution of the service requests among the various IP Services 141-145. Therefore, in an exemplary embodiment, the service request might be initially routed to IP Service 141, but if IP Service 141 is overloaded, then the service request is routed to IP Service 142. In a further embodiment, the DNS SRV 160 can attach attributes to the SS address that result in sending 50% of the service requests from Company One 110 to server 143 and the other 50% of the SIP service requests to server 145. Each of these hostnames, port numbers, IP addresses and associated attributes are stored in a directory within the Private Account-Based DNS Records 165 database.

IP Services 141-145 comprise a plurality of server clusters for processing various service requests. The SS address allows specific service requests to be routed to specific IP servers 141-145 based on the information associated with the service requests. As the IP Services 141-145 receive the service requests, they execute the appropriate processing of the service requests. In some cases, they may return the results back to the appropriate IP telephony device 111-113, 121-123 using the IP address of the IP telephony device 111-113, 121-123 that originated the request.

In an embodiment, the results output from the IP Services 141-145 can also be routed back the originating IP telephony device 111-113, 121-123 using a “reverse proxy” service feature in the Proxy Services 130-132. For example, the DS address associated with each service request can contain account information that links the service request to the IP telephony device that originated the request.

A service request is routed to the specific server 141-145 designated to process the service request. The service request may be, for example, a SIP service request.

The SIP protocol works in conjunction with several other application layer protocols that identify and carry the session media. SIP works in concert with several other protocols and is only involved in the signaling portion of a communication session. A motivating goal for SIP is to provide a signaling and call setup protocol for IP-based communications that can support a superset of the call processing functions and features present in traditional PSTN 115 networks. SIP by itself does not define these features; rather, its focus is call-setup and signaling. The features that permit familiar telephone-like operations—dialing a number, causing a phone to ring, hearing ringback tones or a busy signal—may be performed by servers 141-145. Therefore, a SIP service request can use a SIP INVITE to establish a media session for delivering packets to the servers 141-145 for further processing and the SIP service request is “processed” when the servers 141-145 respond to the IP telephony device 111-113, 121-123, with a SIP “ACK” or acknowledgement that confirms a reliable message exchange. There are also a plurality of other SIP (or IP) messages that can be exchanged between the servers 141-145 and the IP telephony devices 111-113, 121-123 to indicate a “processed” request. The method for managing and routing these service requests will be explained in the discussion of FIG. 2 below.

Turning now to FIG. 2, a flow chart describing a method 200 for managing and routing service requests using Account-Based DNS addresses is illustrated. The method starts at step 205 and proceeds to step 210.

At step 210, Proxy Service 130 receives a service request from IP telephony device 111. For example, the service request may be a SIP service request. As mentioned above, SIP service requests can include, for example, SIP INVITE, SIP ACK and SIP BYE messages.

At step 220, the Proxy Service 130 (for example, through the ABDNS Service Lookup 135) dynamically constructs an SS address so that the associated SIP service request can be routed to one of IP Services 141-145 that can execute the service request. Proxy Service 130 may parse the SIP service request to determine the account ID (e.g., “Account 1”) associated with the request. It may determine the service type (e.g., “Call handler”) also by parsing the SIP service request. A service level (e.g., “Premium”) may further be determined based on the SIP service request itself, or based upon a lookup via, for example, the account ID.

Based on the determined criteria, the Proxy Service 130 may construct an SS address URL. For example, the Proxy Service 130 may dynamically construct an SS address URL based on the pattern “www.vonage.[account_ID].[service_type].[service_level]com.” Based on determining that the account ID is “Account 1,” the service type is “Call handler,” and the service level is “Premium,” the Proxy Service 130 may construct the SS address URL “www.vonage.account1.callhandler.premium.com.”

Turning now to step 230, Proxy Service 130 transmits the SS address to the Private DNS Service 160 to resolve the SS address to an IP address of one of the IP Services 141-145, for example, IP Service 141. At step 240, the resolved IP address is received at the Proxy Service 130. At step 250, the service request is routed to the resolved IP address, to IP Service 141. The method ends at step 260.

Turning now to FIG. 3, one skilled in the art will appreciate that the systems and methods disclosed herein can be implemented via a general-purpose computing device in the form a computer or computer server 301 (herein after “computer”). The components of the computer 301 can comprise, but are not limited to, one or more processors or processing units 303, a system memory 312, and a system bus 313 that couples various system components including the processor 303 to the system memory 312. In the case of multiple processing units 303, the system can utilize parallel computing.

The system bus 313 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Private Branch Exchange (PBX) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 313, and all buses specified in this description can also be implemented over a wired or wireless network connection and each of the subsystems, including the processor 303, a mass storage device 304, an operating system 305, software 306, data 307, a network adapter 308, system memory 312, an input/output interface 310, a display adapter 309, a display device 311, a human machine interface 302, can be contained within one or more remote computing devices 314a,b,c at physically separate locations, connected through buses of this form, in effect implementing a fully distributed system.

The computer 301 typically comprises a variety of computer readable media. Exemplary readable media can be any available media that are accessible by the computer 301 and comprise, for example, both volatile and non-volatile media, as well as, removable and non-removable media. The system memory 312 comprises computer readable media in the form of volatile memory, such as random access memory (RAM), and/or non-volatile memory, such as read only memory (ROM). The system memory 312 may contain data such as media, video, audio, or other data 307 and/or program modules such as an operating system 305 and software 306 capable of manipulating, translating, transcoding, or otherwise editing the data 307 that are immediately accessible to and/or presently operated on the by the processing unit 303.

In another aspect, the computer 301 can also comprise other removable/non-removable, volatile/non-volatile computer storage media. By way of example, FIG. 3 illustrates a mass storage device 304, which can provide non-volatile storage of computer code, computer readable instructions, data structures, program modules and other data for the computer 301. For example, a mass storage device 304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 304, including by way of example, an operating system 305 and hosted VoIP PX software 306. Both the operating system 304 and hosted VoIP PX software 306 (or some combination thereof) can comprise elements of the programming and the hosted VoIP PX software 306. Media, video, audio, or other data 307 can be stored in any of one or more databases known in the art. Examples of such databases comprise, DB2®, Microsoft ® Access, Microsoft® SQL Server, Oracle®, MySQL, PostgreSQL, and the like. The databases can be centralized or distributed across multiple systems. Examples of hosted VoIP PX software include Asterisk®, FreeSwitch®, or Microsoft Lync® server software.

In another aspect, the user can enter commands and information into the computer 301 via client device or an input device (not shown). Example of such input devices comprise a keyboard, pointing device (e.g., a “mouse”), a microphone, a joystick, a scanner, tactile input devices such as gloves, and other body coverings, and the like. These and other input devices can be connected to the processing unit 303 via a human machine interface 302 that is coupled to the system bus 313, but also can be connected by other interface and bus structures, such as a parallel port, game port, IEEE 1394 Port (also known as a Firewire port), a serial port, or a universal serial bus (USB).

In yet another aspect, a display device 311 can also be connected to the system bus 313 via an interface, such as a display adapter 309. It is contemplated that the computer 301 can have more than one display adapter 309, and the computer 301 can have more than one display device 311. For example, a display device can be a monitor, an LCD (Liquid Crystal Display), or a projector. In addition to the display device 311, other output peripheral devices can comprise components such as speakers (not shown) and a printer (not shown), which can be connected to the computer 301 via input/output interface 310. Any step and/or result of the methods can be output in any form to an output device. Such output can be any form of visual representation, including but not limited to, textual, graphical, animation, audio, tactile, and the like. The display 311 and computer 301 can be part of one device, or separate devices.

The computer 301 can operate in a networked environment using logical connections to one or more remote computing devices 314a,b,c. By way of example, a remote computing device can be a personal computer, portable computer, smartphone, softphone, client device, a server, a router, a network computer, a peer device or other common network node, and so on. Logical connections between the computer 401 and remote computing device 314a,b,c can be made via a network 315, such as a local area network (LAN) and or a general wide area network (WAN). Such network connections can be through a network adapter 308. A network adapter 308 can be implemented in both wired and wireless environments. Such networking environments are conventional and commonplace in dwellings, offices, enterprise-wide computer networks, intranets, and the Internet.

For purposes of illustration, application programs and other executable program components such as the operating system 305 are illustrated herein as discrete blocks, although it is recognized that such programs and components reside at various times in different storage components of the computing device 301, and are executed by the data processor(s) of the computer. An implementation of media manipulation software 306 can be stored on or transmitted across some form of computer readable media. Any of the disclosed methods can be executed by computer readable instructions embodied on computer readable media. Computer readable media can be any available media that can be accessed by a computer. By way of example and not meant to be limiting, computer readable media can comprise “computer storage media” and “communications media.” “Computer storage media” comprises volatile and non-volatile, removable and non-removable media implemented in any methods or technology for storage of information such as computer readable instructions, data structures, program modules, or other data. Exemplary computer storage media comprises, but is not limited to RAM, ROM, EEPROM, flash memory or memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence (AI) techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent system (e.g. expert interference rules generated through a neural network or production rules from statistical learning).

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an API, reusable controls, or the like. Such programs may be implemented in a high level procedural or object-oriented programming language to communicate with a computer system. However, the program(s) can be implemented in assembly or machine language. In any case, the language may be a compiled or interpreted language and it may be combined with hardware implementations.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, mobile phones, softphones, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system for routing service requests comprising:
a proxy service configured to receive a service request from an Internet protocol (IP) device and generate a URL based on at least one parameter contained in the service request;
a domain name system (DNS) configured to receive the universal resource locater (URL), resolve the URL into an address, and transmit the address to the proxy service; and
a feature server associated with the address that is configured to receive the service request from the proxy service and to transmit a message responsive to the service request.

2. The system of claim 1, wherein the at least one parameter contained in the service request comprises at least one of an account identifier, a service type, or a service level.

3. The system of claim 1, wherein the proxy service is configured to transmit a lookup request to an account information database based on the at least one parameter contained in the service request, receive additional information responsive to the lookup request, and generate the URL based also on the additional information.

4. The system of claim 1, wherein the address is an IP address or a network protocol address.

5. The system of claim 1, wherein the service request is a SIP request or an HTTP request.

6. A method for routing for a service request comprising;
receiving a service request from an Internet protocol (IP) device;
generating a URL based on at least one parameter contained in the service request;
receiving a resolved address responsive to the URL; and
transmitting the service request to the resolved address.

7. The method of claim 6, wherein the at least one parameter contained in the service request comprises at least one of an account identifier, a service type, or a service level.

8. The method of claim 6, further comprising:
transmitting a lookup request based on the at least one parameter contained in the service request;
receiving additional information responsive to the lookup request; and
generating the URL based also on the additional information.

9. The method of claim 6, wherein the address is an IP address or a network protocol address.

10. The method of claim 6, wherein the service request is a SIP request or an HTTP request.
